(19) United States
(12) Patent Application Publication
(10) Pub. No.: US 2016/0246947 A1
(43) Pub. Date: Aug. 25, 2016

(54) SYSTEM FOR INTERACTIVE PROFILING OF HEALTCARE CONSUMERS TO PROVIDE DIGITAL PERSONALIZED HEALTH GUIDES AND DIGITAL MARKETING

(71) Applicant: UNIVFY INC., Los Altos, CA (US)

(72) Inventor: MYLENE WEI MING YAO, LOS ALTOS, CA (US)

(73) Assignee: UNIVFY INC., LOS ALTOS, CA (US)

(21) Appl. No.: 15/048,821

(22) Filed: Feb. 19, 2016

Related U.S. Application Data
(60) Provisional application No. 62/118,361, filed on Feb. 19, 2015.

(51) Int. Cl. G06F 19/00

(52) U.S. Cl. CPC G06F 19/363

(57) ABSTRACT

A system including (A) an interactive digital profiling questionnaire directed to a health consumer, wherein the questions relate to a health status or condition of the consumer; (B) a consumer health profile that includes a data presentation software application with pre-defined sections, wherein the consumer's answers from the interactive digital questionnaire are entered as health data into the pre-defined sections of the data presentation software application; and (C) a digital personalized health guide for delivery to the consumer that includes logic programs, a concatenation function, and pre-defined topical categories, wherein the logic programs and the concatenation function retrieve health data from the consumer health profile and organize the health data into the pre-defined topical categories. The digital personalized health guide is presented to the consumer with a style appropriate to the consumer's perception of their health status or condition and the consumer can view the health data in the digital personalized health profile according to any of the pre-defined categories.

This application claims priority under 35 U.S.C. §119 to U.S. Provisional Patent Application No. 62/118,361 filed on Feb. 19, 2015, which is incorporated in its entirety herein.

### TECHNICAL FIELD

The present invention relates generally to digital marketing. More specifically, the present invention relates to a system for interactive digital health profiling to determine, generate, and deliver personalized and actionable health guides and digital marketing to a health consumer.

### BACKGROUND OF THE INVENTION

There is a concerted effort by traditional and emerging healthcare stakeholders to empower consumers to take on a greater decision-making role in choices related to their healthcare. The resulting consumer-driven health market is expected to result in getting better value for the healthcare dollar in terms of health benefits to the consumer.

A consumer-driven health market requires the health consumer to be knowledgeable or to know how to gain knowledge about provider, diagnostics and treatment options, including the benefits, efficacy, cost, and complications of prescription drugs, over-the-counter-drugs, surgical procedures, diagnostic tests, monitoring equipment, digital products and/or other alternative options that may be considered for the consumer's specific health needs.

A consumer-driven health market also requires methods for delivering return-on-investment (ROI)-based digital marketing, which in turn will enable the efficient commercialization and marketing of innovative health technologies developed by pharmaceutical, biotechnical, diagnostics, and health tech companies.

Methods used in providing ROI-based digital marketing in the digital sale of consumer goods (i.e., in an e-commerce marketplace) may not provide ROI to advertisers when marketing health products directly to consumers. The decision regarding a certain treatment option or health product is often complex, and involves multiple steps that are not all under the control of the consumer, or observable by the advertiser and/or the marketer.

For example, from the time that the consumer is aware of a certain health product to the time when the health product is needed or applicable, the consumer may have undertaken one or more of the following actions (referred to herein as “health needs navigation”): the consumer becomes aware of his or her health needs and the consequences of not taking action; the consumer seeks medical consultation with an appropriate healthcare provider; the consumer undergoes one or more diagnostic tests; the consumer consults a healthcare provider who will discuss diagnosis and recommend treatments; the consumer learns about insurance coverage and/or out-of-pocket costs for the recommended treatments; the consumer discusses their health needs with family, friends, online health references, and/or obtains a second medical opinion from another provider. Each consumer may be different in the amount of health information that she desires or can digest, at a particular time point. Providing too much or too little information at the wrong time could harm efforts to build trust and credibility. Aside from these steps, physical, psychological, emotional, social, and/or financial concerns may also impact the consumer's readiness to take in, or bias him or her against, new information and/or make a health decision. Understanding these influences outside of the consumer's physical health data, and addressing these issues may help the consumer to accept information about his or her health and health products that are potentially beneficial to him or her.

Among the many challenges of marketing to the health consumer is the need to know not just the medical condition and demographics, but additional information, including where he or she is in his or her health needs navigation. It is also important to stay up-to-date with changes, including obstacles and progress in his or her health needs navigation.

ROI-based digital marketing methods used in e-commerce often use data from a combination of keywords and/or text-based contextual data from online searches; consumer profiling based on demographics, and behavior, including other online activities, purchases, and connections and behavior in and among social networks. Real-time analytics of consumer profile and behavior data is often integrated with ad-serving and retargeting platforms, and on-site optimization to maximize conversion to sales. Marketers can measure the ROI, in terms of advertising dollars spent, the number of consumers targeted, and the percentage or number of consumers that are targeted and moved along each step along each conversion step to the closing the sales.

However, ROI-based digital marketing cannot be applied directly to consumer health marketing. Information such as the specific nature of a health condition, its severity, and the impact of the condition on the consumer's work and lifestyle may be difficult to extract or infer from the data obtained through ROI-based digital marketing methods. Such information may be limited by the availability of health content that specifically reflect such context, and the consumer's ability to research a particular health condition in a way that's relevant to his or her specific needs and concerns. Without these data points, the marketing of health products to the consumer may not be sufficiently specific in terms of his or her health needs navigation at a particular time point (e.g., seeing a provider, awaiting diagnostics results, or awaiting discussion of treatment options with a provider), digital channel, or value proposition, to convert the consumer into sales and a customer.

Other methods used by digital health content websites or consumer health apps to apply more specific targeting, involve using a consumer's response to a questionnaire to build a profile, and then using the profile data to determine the appropriate health information content to send to the consumer about a specific health topic. The consumer health profile data includes contact information and an opt-in permission to send personalized health guides to the consumer via email address, phone number (verbal or texting), social media private pages or messages, or mailing address. Further, the consumer profile may trigger certain types of messages to be sent to the consumer via text, email, social media, or other medium, to increase consumer engagement, “stickiness” or recurrent and frequent usage of the app, promotion of health products. However, health information content is often limited to generic templates or crude personalization according to broad categories of health needs, with no or minimal differentiation based on the consumer's emotional state, level of concern, his or her health needs navigation, and/or recommendations from healthcare providers.

Additionally, ROI-based marketing requires targeting of sponsored content or advertising to be specific and its attribution to sales to be reportable or discoverable. Since health products often market to consumers, providers, and/or payers, it may be difficult to attribute ROI to each audience that is being marketed to. These challenges in digital health marketing may affect investments made by health product companies to provide educational outreach and to market to consumers about their health options. Among the health conditions affected by the challenges in digital marketing are chronic diseases and a wide range of health conditions typically placed under the category of women's health.

### SUMMARY OF THE INVENTION

The present invention overcomes the challenges of digital healthcare marketing by providing an interactive digital profiling platform for obtaining health information from a consumer, a consumer health profile for compiling relevant information from the interactive digital profile, and a personalized health guide developed from the consumer health profile for delivery to the consumer, the latter of which includes actionable items from the digital healthcare marketplace.

In one embodiment, the present invention provides a system comprising: (A) an interactive digital profiling questionnaire directed to a consumer of health information, wherein the consumer provides answers to questions provided in the interactive digital profiling questionnaire, wherein the questions and answers relate to a health status or condition of the consumer and the questions are presented to obtain information about the consumer's perception of the health status or condition; (B) a consumer health profile comprising a data presentation software application comprising pre-defined sections, wherein the consumer's answers from the interactive digital questionnaire are entered as health data into the pre-defined sections of the data presentation software application , wherein the consumer health profile is not visible to the consumer; and (C) a digital personalized health guide for delivery to the consumer comprising one or more logic programs, a concatenation function, and pre-defined topical categories, wherein the one or more logic programs and the concatenation function retrieve health data from the consumer health profile and organize the health data into the pre-defined topical categories, and further wherein the health data is provided to the consumer with a presentation style appropriate to the consumer's perception of the health status or condition and the consumer can view the health data in the digital personalized health profile according to any of the pre-defined categories, wherein the pre-defined topical categories of the computer-generated personalized health guide will vary in content, length, complexity, tone, style, seriousness, and detail depending on (i) the answers provided by the consumer in the interactive digital profiling questionnaire, (ii) the health data in the pre-defined sections of the consumer health profile, and (iii) the organization of the health data by the one or more logic programs and the concatenation function of the digital personalized health guide.

In another embodiment, wherein the interactive digital profiling questionnaire is selected from the group consisting of a text-based questionnaire, a non-textual visual questionnaire, an audio-based verbal questionnaire, and a video-based questionnaire. The answers to the non-textual visual questionnaire, the audio-based verbal questionnaire, and the video-based questionnaire may be converted to text for automatic entry into the data presentation software application of the consumer health profile.

In a further embodiment, the interactive digital profiling questionnaire of includes questions relating to the consumer's physical, psychological, emotional, social status, financial status, and interest in the health status or condition. In another embodiment, the data presentation software application is a spreadsheet or a set of content look-up tables. The data presentation software application may use a mail merge function to concatenate content of the digital personalized health guide.

In another embodiment, the one or more logic programs of the digital personalized health guide are selected from the group consisting of Markov decision processes, hierarchical task networks, natural language processing, machine learning, statistical methods, neural network, and Bayesian networks.

In a further embodiment, the pre-defined topical categories of the digital personalized health guide are selected from the group consisting of demographics, general health status, general health needs, lifestyle information, family health history, laboratory data, and the consumer's needs in relation to the consumer's health status or condition.

In another embodiment, the consumer is an individual or a couple and the health status or condition is fertility and/or a live birth of one or more healthy children, wherein the individual or couple is learning about his/her/their fertility; learning how to preserve his/her/their fertility potential; attempting to conceive; or undergoing fertility treatment. Here, the digital personalized health guide may include an analysis on how the consumer's lifestyle, activities, finances, and physical, psychological, and social well-being influence the consumer's fertility status or condition, the latter of which may be selected from the group consisting of perceived fertility potential, perceived probability of a live birth event from one or more fertility treatments, and level of concern about fertility. The digital personalized health guide may further include recommendations for treatments and advertisements for products that may improve the consumer's fertility status or condition.

In another embodiment, the consumer is an individual or a couple that is trying to conceive or is expecting one or more children and the health status or condition is selected from the group consisting of maximizing health of a fetus or unborn child, minimizing risk of disease of a fetus or unborn child, and minimizing harmful effects of a known or potential disease to a fetus or unborn child.

In a further embodiment, the consumer is an individual or a couple and the health status or condition is the consumer's interest in having a healthy child or interest in learning how to have a healthy child, wherein the health status or condition leads the consumer to receive pre-conception health recommendations selected from the group consisting of exercise programs, diet information, nutritional supplements, lifestyle changes, pre-conception genetic testing of the consumer and/or the consumer's partner to determine carrier status for genetic diseases, prenatal genetic testing, and genetic testing of family members of the consumer. Family members of the consumer may be selected from the group consisting of offspring of the consumer, immediate family members of the consumer, and extended family members of the consumer.

In another embodiment, the consumer is an individual or a couple and the health status or condition is selected from diagnostic or screening tests to select embryos with a high likelihood of viability and/or a low risk of serious health conditions, wherein the genetic tests are selected from the group consisting of time-lapse imaging of pre-implantation embryo development, pre-implantation genetic screening, pre-implantation genetic diagnosis, biochemical testing, testing of metabolites in a pre-implantation embryo culture environment, screening for genetic variants in embryos, screening for genetic variants in a male that is a sperm source of an embryo, and screening for genetic variants in a female that is an egg source of an embryo.

In a further embodiment, the consumer is an individual and the health status or condition is selected from the group consisting of assessing the consumer's risk of developing one or more diseases, preventing or delaying onset of one or more diseases that pose a health risk to the consumer, and ameliorating symptoms of one or more pre-existing diseases of the consumer, the latter of which may be selected from the group consisting of cancer, Alzheimer's disease, Parkinson's disease, cardiovascular diseases, kidney diseases, diabetes, and liver diseases. Additional pre-existing conditions may include flares of a chronic infectious illness, such as hepatitis B, hepatitis C, human immunodeficiency virus (HIV); or autoimmune diseases, such as multiple sclerosis, rheumatoid arthritis.

In another embodiment, the digital personalized health guide includes information for assessing the consumer's risk of developing one or more diseases, information for preventing or delaying onset of one or more diseases, and information for ameliorating symptoms of one or more pre-existing diseases, wherein the information is selected from the group consisting of genetic screening tests, genetic diagnostic tests, and re-analysis of previously performed genetic tests.

In a further embodiment, the digital personalized health guide includes information on menopausal health selected from the group consisting of lifestyle changes to decrease unpleasant menopausal symptoms, diet changes to decrease unpleasant menopausal symptoms, cardiovascular health, bone health, emotional wellness, and enhancement of sexual function.

Additional advantages and embodiments of the invention will be provided, without limitation, in the detailed description of the invention that is set forth below.

### DETAILED DESCRIPTION OF THE INVENTION

Set forth below is a description of what are currently believed to be preferred embodiments of the claimed invention. Any alternates or modifications in function, purpose, or structure are intended to be covered by the claims of this application. As used in this specification and the appended claims, the singular forms “a,” “an,” and “the” include plural referents unless the context clearly dictates otherwise. The terms “comprises” and/or “comprising,” as used in this specification and the appended claims, specify the presence of stated features, integers, steps, operations, elements, and/or components, but do not preclude the presence or addition of one or more other features, integers, steps, operations, elements, components, and/or groups thereof.

Definitions

“Consumers” means consumers, health consumers, patients, or individuals who are users of or who directly or indirectly purchase health products for themselves or others. Consumers includes family, guardians, or individuals who are caring for one or more individuals who are or will be receiving care from health providers and/or licensed health facilities.

The term “health” refers to a consumer's physical, emotional, social, or psychological well-being unrelated to any medical conditions; or related to the prevention, risk factors, causes, development, diagnosis, current, ongoing or past treatment, recurrence, recovery, and consequences of a medical condition; or related to the impact of any aspect of a medical condition on the consumer's physical, emotional, social, or psychological well-being. Within the context of the present invention, the term “health” is meant to be interchangeable with disease, illness, fitness, medical condition, sickness, disability.

“Health products” means health services and/or digital or material products that are designed and intended to meet one or a plurality of health needs of consumers, and comprise information, education, monitoring, devices, health and fitness equipment, medicine, dietary or health supplements. Health products may be personalized to the specific health needs of one or a plurality of consumers.

The term “health product information” refers to information that is provided by one or a plurality of health providers, one or a plurality of consumers such as in customer review, or editorial department; or the information may be sponsored by businesses or non-profit organizations such as pharmaceutical companies, device companies, for-profit or non-profit health providers, non-profit organizations; or the information may be a paid advertisement with no monetary value, or a coupon giving a specified discount, rebate giving a specified dollar amount, or other methods of rewarding the consumer for using the advertised health product.

The term “digital products” refers to products that are sold, delivered, or served via web-based applications (“web apps”, thereafter), mobile applications (“mobile apps”, thereafter), video streaming, social media channels, cloud-based services, texting or messaging, email, web- or wireless- or text-based communications, and maybe in one or a plurality of formats, including text, picture, emoticons, video, audio, posts through social media, or any hard copy reproductions of the preceding formats. The words digital, virtual, and electronic may be used interchangeably.

The term “health services” refers to digital or in-person interactions, visits, consultations, diagnostics, medical, surgical, or any other treatments that are provided by licensed health professionals or licensed health facilities.

The term “licensed health professionals” includes, but is not limited to physicians, nurses, nurse practitioners, dentists, psychologists, optometrists, chiropractors, and alternative medicine providers, the latter including without limitation, acupuncturists, therapists, technicians, paramedics, and support services related to the co-ordination or procurement of health products and/or services, such as care coordinators, administrators, account representatives, and customer support.

The term “licensed health facilities” refers to virtual or physical facilities in which treatments or health services are delivered, including inpatient facilities, outpatient facilities, hospitals, hospices, rehabilitation centers, healthcare networks, clinics, surgical centers, mobile facilities, transporters, providers providing house calls, or providers of healthcare during travels.

“Treatments” means a single, one-time health service; ongoing health services; a set of concurrent treatments that aims to obtain a certain health result; a series of sequential treatments that aim to obtain a certain health results; a bundle or package that may or may not include treatments and supportive services required to receive treatments; a set of treatments that includes a primary first-line treatment with or without alternative treatments that will be used if the primary treatment fails, produces suboptimal results, or complications; a set of treatments that includes a primary treatment with or without treatments that are necessary for treatment complications that result from the primary treatment.

“Efficacy” means a measure of a treatment outcome for an individual that includes one or more of improved bodily functions; improved quality or extension of life; ability to carry out normal or above normal functions; decreased physical, mental, or emotional suffering; or the substitution, replacement, or correction of a defective or flawed bodily function. Efficacy, including any of the foregoing measures, can be expressed as the percentage of patients that has a certain positive outcome, complication, side effect, negative outcome, or an outcome in which another treatment or a series of the same treatments, or a set of different treatments, is needed. Efficacy can also be expressed as a distribution curve, histogram, or a table which shows the percentage of patients having a certain level or grade of success or failure in outcome. Efficacy can also be expressed as the percentile of patients that have an outcome above a certain success threshold.

“Cost” means the price that a consumer would have to pay in exchange for, or to receive, a treatment or health services, unless “cost” is explicitly qualified by “cost to the provider,” “cost to stakeholders,” or any other definition. Cost can be provided in terms of the price or fee that a consumer would have to pay to receive different components of health services that together, constitute a treatment; for example, if a consumer needs knee surgery, she may have to pay a fee to the orthopedic surgeon, surgical facility, anesthesiologist, and any anesthetic medicine or diagnostics that are given pre-surgically, during, and after surgery. Each fee can be presented as a separate cost to the consumer, and traditionally, the consumer may have to add them all up to determine what the total cost of surgery is. Alternatively, the cost can be a bundled payment that is a single fee quoted to the consumer by the medical provider, directly or via this invention. The bundled payment encompasses all costs to different individuals and facilities that are involved in providing the knee surgery. The bundle payment may simply be the sum of all the separate costs, or it may have been developed by different pricing mechanism that does not necessarily reflect the cost of each professional or facility fee, but is the result of marketing and cost considerations. The cost may or may not represent the total cost to the consumer which may or may not be reimbursable by the insurance carrier, and costs to third parties such as employers or insurance carriers may be considered separately. In any case, the definition of cost will be specified by the invention.

“Medical insurance” means medical insurance plans paid fully or partially by employer, government, third party credits, the consumer and/or the consumer's family or spouse or partner, in which third party credits include access to health services provided by a state's exchange or any other currency that can be exchanged for health services.

The term “advertisements” is meant to refer to products or methods to create value or save costs for the consumer. Examples of advertisements include coupons, monetary rewards, reward points redeemable towards the purchase of other health or consumer products, tracked discounts, and rebate programs. , Within the context of the present invention, advertisements may be delivered to the health consumer as part of the personalized actionable health guide for which a ROI can be measured.

The terms “contextual,” “contextual information,” and “contextual data” are used interchangeably herein to refer to words or symbols that explain the meaning of the phrase or statement in which it occurs. For example, within the context of the present invention, a consumer may response to a question presented in the questionnaires described herein with a contextual answer that describes the consumer's individual experience with the scenario presented in the question.

The term “personal data” is used to refer to data provided by a consumer that is not related to any particular context. Personal data includes facts relating to an individual, such as age, gender, height, weight, place of residence, occupation, etc.

The term “women's health” includes, but is not limited to, decisions regarding birth control, sexually transmitted disease prevention or treatment, trying-to-conceive, the management of pregnancy and any health issues or complications arising from it, fertility problems, problems with menstrual cycles, irregular menstruation, or other menstrual symptoms, menopause and health issues arising from the transition to menopause, female sexual concerns or dysfunction, genetic testing including preconception, prenatal, embryonic (pre-implantation genetic screening or diagnosis), and genetic testing performed for a male or female at any age to assess the individual's risks of certain health conditions, his/her family member's risks of certain health conditions, or to ascertain the genetic cause of a health condition. Obstetrical care may also fall under women's health. Women's health may also include conditions that have a disproportionately high prevalence in women, such as migraine headaches, lupus and multiple sclerosis.

The term “chronic disease(s)” includes, but is not limited to, treatment or disease management decisions regarding conditions such as migraine headaches, eczema, arthritis, chronic inflammatory bowel disease, constipation, chronic sinusitis, glaucoma, hearing loss, hypertension, diabetes, heart disease, chronic vascular insufficiency, recurrent bladder infection, kidney stone, heart burn and indigestion, chronic diarrhea, chronic liver disease, musculoskeletal conditions such as tendonitis, fibromyalgia and fasciitis, multiple sclerosis, and psychiatric illnesses such as depression and anxiety.

Interactive Digital Profiling Platform

In one embodiment, the system of the present invention provides an interactive digital profiling platform that is designed to obtain information about the specific health status and needs of the consumer, including without limitation, the consumer's physical, psychological, emotional, and social well-being generally or with respect to a specific health area of interest; the consumer's financial status; and the consumer's desire, willingness, and/or readiness to digest varying amounts and depths of relevant health information. In a preferred embodiment, the interactive digital profiling platform is a questionnaire, wherein the consumer provides answers to questions provided in the interactive digital profiling questionnaire, wherein the questions and answers relate to a health status or condition of the consumer and the questions are presented to obtain information about the consumer's perception of the health status or condition. It is to be understood that all discussions herein regarding the interactive digital profiling platform are inclusive of interactive digital profiling questionnaires.

The interactive digital profiling platform may be text-based, non-textual, audio-based, or video-based. In the text-based embodiment, the platform presents health-related questions in a quiz format with answers to the questions in the quiz provided in a text-based multiple choice format or in a written response format. The written response format may be designed to have word or character limit, such as for example a 250 word or 1000 character limit, or a 500 word or 3000 character limit. The platform is thus able to obtain information about the consumer by way of the consumer's multiple choice or written answers to the quiz. In the non-textual embodiment, visual representations, such as pictures, icons, emoticons, and/or storyboards are used instead of text-based questions and answers. With the non-textual embodiment, answers to the questions will be limited to multiple choice answers. The consumer's answers in the non-textual questionnaire are simultaneously or subsequently converted by the platform into text-based answers for further analysis. In the audio-based embodiment, the platform presents the consumer with spoken questions to which the consumer responds verbally. Ideally, the audio platform is equipped with voice to text transcription software so that the consumer's verbal answers to the platform's audio questions may be stored in a text-based format. In the video-based embodiment, the platform presents the consumer with an interactive video presentation wherein the consumer can interact with a specific frame or series of frames in the video. The video become interactive when within a particular frame, a digital button appears that the consumer can press to indicate that they are choosing to interact with the video. When the consumer presses the interactive button, the video will create a new frame with a question, which may be answered via text or alternatively, via an audio or video recording. In an alternative embodiment, the consumer will watch a video describing the interactive profiling platform and will respond to questions presented in the video as instructed. For example, the video may have a host that requests that the consumers log into a website where answer to the questions presented by the host may be answered via text or audio or video recordings.

In another embodiment, the interactive digital profiling platform may present open-ended questions for which no responses are provided, and the consumer is asked to answer freely in his or her own words, by typing or speaking his or her response, or by providing his or her response in the form of pictures. For example, the consumer may be given a scenario and asked to answer multiple choice questions or provide his or her thoughts in a written response. Alternatively, the platform may ask the consumer to write or speak about his or her ideas or experiences or to submit questions regarding a specific health topic.

In any of the foregoing interactive digital profiling platforms, i.e., the text-based, non-textual, audio, or video platforms, the answers provided by the consumer form the basis for the digital personalized health guide that will be provided to the consumer.

The interactive digital profiling of the present invention is intended to be direct and transparent, which means the consumer is fully informed that data is being collected from him or her for the purpose of determining and delivering health information, recommendations, and/or health product information that is personalized to his or her specific health profile, including his or her health status and needs.

The interactive digital profiling of the present invention may be presented to the consumer through any of the following platforms: an on-line website, email transmission, a search engine, a social media platform (such as Facebook® or LinkedIn®), a mobile app (such as WhatsApp® and WeChat®), texting via mobile device, video communications (such as Skype®), real-time texting such as Linx®, audio- or voice-based communications, or a kiosk.

In one embodiment, the interactive digital profiling platform of the present invention learns about the impact of various health factors on the consumer's subjective and observed physical, psychological, and social well-being.

“Physical well-being” means any physical effects that are subjectively felt by the consumer or objectively observed by a healthcare provider or another individual such as a friend or family member. Examples of physical effects include without limitation, skin rash, itchiness, headaches, dizziness, visual disturbances, hearing loss, sinus symptoms, cough, sore throat, difficulty breathing, wheezing, short of breath, palpitations, abnormal blood pressure, irregular heart rhythm, weight gain or loss, abdominal/pelvic pain, vomiting, nausea, difficulty swallowing or eating, diarrhea, urinary discomfort, bladder control problems, bleeding in the urine, blood in the stool, constipation, bloating, vaginal discharge, abnormal vaginal bleeding, sexual dysfunction, erectile dysfunction, tingling, paralysis, weakness, loss of consciousness, and stiffness, swelling, redness, sores, and/or tenderness anywhere in the body.

“Psychological well-being” means any psychological effects or psychiatric symptoms that are subjectively felt by the consumer or objectively observed by a healthcare provider or another individual such as a friend or family member. Examples of psychological effects or psychiatric symptoms include without limitation, subjective sensation of emotional stress, restlessness, nervousness, inertia, sleepiness, sleeplessness, sadness, depression, inability to enjoy usual pleasures, food avoidance, anger, fear, paranoia, hallucination, confusion, memory loss, mania, decreased affect or expression, teariness, violence, desire to harm oneself, etc.

“Social well-being” means the consumer feels that his or her ability, desire, or motivation to relate to one or more individuals, such as spouse, family members, friends, superiors at work, co-workers, or virtual social network, is different in quality or frequency of interactions. Or, the impact of social relationships with one or more of the above individuals, has on the consumer is different in terms of quality or importance. Impact or changes in social well-being also includes a difference quality, frequency, or impact of social relationships as observed by others who know the consumer, even if the consumer does not subjectively feel the impact himself or herself.

It is to be understood that some factors may be shared among the categories of physical, psychological, and social well-being.

Where the interactive digital profiling platform is directed to a specific health area, the interactive profiling may be constant or may change over time, or there may be more than one specific health area of focus. Health areas contemplated under the present invention include a wide range of health conditions, such as for example, women's health (including contraception), sexually transmitted diseases or protection from them, clinical infertility, sexual dysfunction, and menopause; chronic diseases including rehabilitation and recovery from an acute illness; cancer, cancer remission, cancer recurrence, side effects or complications of cancer treatment; musculoskeletal, joint, or bone conditions; mental illness; rehabilitation or recovery from an acute illness, trauma, or acute exacerbation of a chronic illness; genetic testing including preconception, prenatal, embryonic (pre-implantation genetic screening or diagnosis), and genetic testing performed for a male or female at any age to assess the individual's risks of certain health conditions, his/her family member's risks of certain health conditions, or to ascertain the genetic cause of a health condition. Or the specific health area may not involve a medical condition or prevention of a medical condition, but instead relates to the subjective need to enhance well-being such as to feel better, feel more energized, feel healthier, feel stronger, feel more alert, take greater pleasure in certain activities including sex, have better skin, have healthier hair, or to develop a stronger immune system to fight common contagious illnesses like the common cold.

In one embodiment, the interactive profiling is conducted to learn about what steps a female consumer has taken with regards to her desire to conceive or receive information about fertility in general, conceiving, or difficulty in conceiving. Although difficulty in conceiving is a medical condition that is an indication to consult a fertility specialist, and likely undergo diagnostic testing and fertility treatment, taking those steps are personal decisions that are impacted by a combination of the consumer's views about having a baby; fertility treatments; financial factors, such as availability of insurance coverage or in the case of self-pay, the amounts of personal funds or loans available; and influences from their lifestyle and social environment.

For example, the interactive profiling platform of the present invention may use a simple quiz of several questions (e.g., anywhere from 10-50 questions), each posed in easy to understand language along with a warm and consumer-friendly picture to obtain personal and contextual information about a consumer's fertility status and needs. Each question may have up to five choices, with some questions allowing more than one choice to be selected. Some of the choices, if selected, will direct the consumer to a different branch of questions. Personal questions will relate to the age of the consumer; whether the consumer is single or has a partner, the consumer's sexual orientation, and whether the consumer is in a heterosexual or same-sex relationship. Contextual questions will relate to whether a female patient is actively trying to conceive or would just like to learn more about fertility. If the consumer is trying to conceive, additional contextual questions will inquire into the length of time she has been trying to conceive, whether she has seen a fertility specialist, and if she has, whether she has undergone fertility diagnostic testing or fertility treatment and the type of fertility treatments. If she is seeing a fertility specialist, further questions may seek information on whether she is happy with her specialist and why. If she has not seen a fertility specialist, the next set of questions may inquire whether she is looking for one and what characteristics she would like to have in her specialist (e.g., male, female, proximity to home, acceptance of a certain insurance carrier, etc.). Here, the pictures used in the quiz will change to reflect the choices that the consumer has selected. For example, if the consumer has indicated that she is in a same-sex relationship, a picture of a female same-sex couple is shown instead of a picture of a heterosexual couple. Similarly, a consumer who has indicated that her age is 42 will be shown pictures of women who appear to be in their early 40s, rather than pictures of women who appear to be in their 20s or 30s.

In a further embodiment, the interactive profiling may also obtain information about the consumer's financial issues, problems, or constraints. Through the use of written responses or branching multiple choice questions, the interactive digital profile of the present invention can learn how the consumer's financial status impacts the consumer's physical, psychological, and social well-being or alternatively, how the consumer's physical, psychological, and social well-being impacts the consumer's financial circumstances. Within the context of the interactive profiling platform, the term “branching multiple choice questions” refers to multiple choice questions that appear on the interactive digital profiling platform based upon responses provided in previous questions.

Consumer Health Profile

The consumer health profile of the present invention comprises a compilation of the data or information collected from the consumer by way of the interactive digital profiling platform, which as described above, may be obtained through multiple choice selection, written text, non-textual visual representations, and/or a verbal response provided via an audio or video platform. The consumer health profile compiles and organizes the data or information from the interactive digital profiling platform by way of a data presentation software application comprising pre-defined sections, wherein the consumer's answers from the interactive digital questionnaire are entered into the pre-defined sections of the data presentation software application. Because the consumer health profile is used to compile the consumer's information, the consumer health profile will typically be a computerized aspect of the present invention that is not be visible to the consumer.

Examples of the type of data or information included in a typical consumer health profile includes without limitation, demographics, general health status and needs, lifestyle information, family health history, laboratory data, and the consumer's health status and needs pertaining to a specific health area of interest. For example, the consumer health profile may include whether the consumer is concerned about his or her status in a particular health area, the level of concern, and how his or her concern about his or her health needs is affecting his or her lifestyle, activities, general physical, psychological, and social well-being.

Demographics comprises information selected from the group consisting of age, gender, sexual orientation, family structure and relationships, ethnicity not just of the consumer herself but ethnicity or immigration history of herself, her family, her partner, and her partner's family, geographical location, neighborhood, school or work environment and type, her own income level, her family's income level, primary and secondary languages of the consumer and her family, the number and ages of dependents, education level, type of work, seniority at work, and demographics of her family, neighborhood, school and work environment.

Lifestyle comprises information selected from the group consisting of typical daily or weekly routine; work and/or school hours, occupation, the demands and nature of her work, studies, leisure, or home responsibilities; number of hours spent on each activity including work, school, transportation, sleep, eating, caring for family, rest, and leisure; the type of leisure activities or hobbies such as singing, playing a musical instrument, painting, reading, creative writing, calligraphy, cooking, sewing, crafts; travels, destinations; the amount, type, intensity, and frequency of exercise; diet in terms of calorie intake, types of food, number and timing of meals; type and frequency of leisure activities and/or entertainment; the amount, extent, and frequency of risk-taking behavior such as speeding, drinking and driving, high risk/impact sports, excessive gambling, unprotected casual sex, other types of compulsion and shoplifting; the types, extent, and frequency of relaxation or relaxing/calming activities; unhealthy activities such as smoking and binge drinking; lifestyle of her family and social peers.

General health status and needs comprises information selected from the group consisting of any history of or current disabilities, health conditions including acute or chronic illnesses, temporary or long term disabilities, dietary needs or restrictions, need for weight loss or gain, medications, allergies, physical fitness, exercise tolerance, normal physiological functions of all body organs or the extent, severity and duration of their dysfunctions, recommendations by healthcare providers.

Family health history comprises information selected from the group consisting of health conditions or illnesses that first, second, and third degree relatives have experienced. Family health history may include hereditary and non-hereditary illnesses for which genetic or other causes have or have not been identified.

Laboratory data comprises information selected from the group consisting of lab test results pertaining to any bodily fluids, tissue-level data, imaging results, and biomarker test results, which may or may not include genetic markers, genomics, whole gene sequencing, or genetic data extracted from discovery platforms. Examples of tissue-level data includes without limitations, immunoassays, quantitative PCR (qPCR), semi-quantitative measurement of transcriptome by gene expression arrays, or whole-transcriptome sequencing.

The consumer health profile may include additional information obtained directly or from third parties about the consumer and his or her online behavior, which includes online activities, purchases, method of navigating the internet, the types of mobile apps downloaded and the frequency and types of app usage, and connections and behavior in and among social networks.

In another embodiment, a consumer health profile may use contextual data collected from the consumer's personalized interactive digital profiling along with additional personal, online behavior, and/or social network data. For example, if the consumer's social network data shows that she is a fan of a certain celebrity who has gone through fertility treatments, and if that celebrity's fertility story fits the context of the fertility health information that the system determines meets the consumer's fertility needs, the fertility guide may mention that celebrity's fertility story, as it may motivate the consumer to be more proactive about the guide's recommendations.

The foregoing demonstrates that a consumer health profile resulting from a simple interactive profiling quiz may generate thousands to millions of versions of fertility health guides, after tailoring to details of the consumer's demographics, general health status, family history, lifestyle factors, consumer's status in terms of her physical, psychological, social, and financial well-being, and details of the health topic of interest, which is fertility health in this example. Based upon the answer provided by the consumer in the interactive digital profiling platform, the consumer health profile may also reflect how the consumer's lifestyle, activities, finances, general physical, psychological, and social well-being, are affecting his or her level of concern about his or her health status and needs.

Digital Personalized Health Guide

The present invention uses the consumer's health profile to generate and deliver a digital personalized health guide to the consumer. The digital personalized health guide will include health information that is specific to the consumer's specific health status and needs, and is delivered in a context that is most appropriate, meaningful, and actionable based on his or her demographics, lifestyle, general health status and needs, and family health history. Where personal data is collected from the interactive digital profiling to build the consumer health profile, the consumer's answers to various questions may be stored in data tables. Data from the consumer health profile may subsequently be retrieved from the data tables to generate content for the digital personalized health guide.

Health information as presented in the digital personalized health guide may include, without limitation, information about normal body functions; abnormal body functions known for different diseases; causes of a health condition or disease; potential treatment options including conventional western medicine, surgical procedures, complementary and alternative medicine approaches, or ways to improve physical, psychological, or social well-being in the presence or absence of a disease; efficacy, potential benefits, risks, complications, and cost of one or more potential treatment options; consequences of not treating the health condition, including financial consequences; healthcare providers who provide one or more treatment options or who are specialists or experts in treating the health condition; potential benefits, risks, and costs of diagnostic tests, including any diagnostic devices or genetic testing; relevant clinical trials; research and clinical trial results; information about how to purchase relevant health products, the cost and/or insurance coverage information regarding health products.

In one embodiment, the digital the digital personalized health guide includes information for assessing the consumer's risk of developing one or more diseases, information for preventing or delaying onset of one or more diseases, and information for ameliorating symptoms of one or more pre-existing diseases, wherein the information is selected from the group consisting of genetic screening tests, genetic diagnostic tests, and re-analysis of previously performed genetic tests.

In a further embodiment, the digital personalized health guide includes information on menopausal health selected from the group consisting of lifestyle changes to decrease unpleasant menopausal symptoms, diet changes to decrease unpleasant menopausal symptoms, cardiovascular health, bone health, emotional wellness, and enhancement of sexual function.

The digital personalized health guide may include any combination of text, non-text visual, audio, or video content, and may further include content that is editorial, sponsored by a non-profit or for-profit entity, or advertisements. Presentation styles of the digital personalized health guides may include variations in writing style, complexity of writing, choice of words, reading levels, non-text visual presentation style and/or colors, tone (e.g., light or serious), voice quality (e.g., soothing, neutral, or urgent), length, formatting, style of speech (e.g., emphatic, suggestive, peer-level, authoritative, formal, informal). Presentation styles may be further tailored to cultural norms based on the consumer's education, demographics, primary language, and/or culture. The presentation styles of the digital personalized health guide are intended to provide new information and/or reinforce information a consumer may already know, but has not yet acted on while delivering the information to the consumer in a manner that acknowledges the consumer's perception of his or her health needs and concerns.

The personalized health guide is contextual in that the tone and presentation of the information in the personalized health guide is tailored to be responsive to the consumer's health status and/or needs; the consumer's level of concern about his or her health status and/or needs; the degree to which any health issues have impacted the physical, psychological, and social well-being of the consumer; any demographics or financial constraints that might impact the consumer's decision to a certain health product or limit the consumer's access to a health product; and other relevant factors from the consumer health profile. In other words, the digital personalized health guide does not just address the health consumer's health status and needs; rather, the digital personalized health guide uses a presentation style that displays an appropriate level of empathy towards the consumer with regard to the consumer's perception and/or concern regarding the consumer's health status and needs. In this same vein, the digital personalized health guide may be modified over time in response to the consumer's increasing or decreasing willingness to digest increasingly complex health information. The consumer's reactions to these issues are obtained through updates to the interactive digital profiling platform.

The digital personalized health guide is actionable in that, for example, sponsored information about health and/or consumer products and advertisements, including tracked discount or rebate programs, may be delivered to the health consumer as part of the digital personalized health guide.

In one embodiment, the digital personalized health guide comprising one or more logic programs, a concatenation function, and pre-defined topical categories.

Within the digital personalized heath guide, the health data is provided to the consumer with a presentation style appropriate to the consumer's perception of the health status or condition and the consumer can view the health data in the personalized digital health profile according to any of the pre-defined topical categories, the latter of which will correspond to the information sought in the interactive digital profiling platform and organized within the consumer health profile. Preferably, the information displayed in each of the pre-defined topical categories may be modified, varied and/or edited. For example, the pre-defined topical categories may vary in content, length, complexity, tone, style, seriousness, and detail depending on (i) the answers provided by the consumer in the interactive digital profiling questionnaire, (ii) the health data in the pre-defined sections of the consumer health profile, and (iii) the organization of the health data by the one or more logic programs and the concatenation function of the digital personalized health guide. In one embodiment, the digital personalized health guide of the present invention includes pre-defined topical categories selected from the group consisting of demographics, general health status, general health needs, lifestyle information, family health history, laboratory data, and the consumer's needs in relation to the consumer's health status or condition.

The concatenation function (such as a mail merge function), which will preferably be automated, will retrieve information from the consumer health profile and organize that information on a computer-implemented spreadsheet program (such as for example, Microsoft Excel®) or alternatively, a set of computerized content look-up tables, to sort and put together multiple sections of pre-defined content and/or categories according to selected answers to the interactive quiz that contribute to the consumer health profile. As is understood by those of skill in the art, mail merge is a method of automating the concatenation of the various different sections of a spreadsheet or set of content look-up tables.

The one or more logic programs pulled by the concatenation function from the consumer health profile and will organize the information into the pre-defined topical categories to form the digital personalized health guides using algorithms and/or techniques selected from the group consisting of Markov decision processes, hierarchical task networks, natural language processing, machine learning, statistical methods, neural network, and Bayesian networks. The one or more logic programs will determine the most appropriate way to display the content within the pre-defined topical categories based upon the health data in the consumer health profile.

In another embodiment, criteria based on demographics, health, and other data obtained from the consumer health guide are defined to determine the differential targeting of advertisements or sponsored content to consumers in the context of their likelihood to need to learn about or purchase a particular health product.

In a further embodiment, advertisements that display coupons, rebates, or a redeemable reward program may provide a promotional or tracking code that the consumer is asked to submit to receive the reward or rebate. This tracking by itself or in combination with differential targeting of the advertisement and/or prior sponsored content will allow the ROI of the health guide, targeting criteria, differential sponsored content or advertisement to be measured and compared.

In another embodiment, consumers are asked to submit their pharmacy receipts after purchasing an advertised product, to a designated email/website to redeem awards or receive rebates as a way to track sales conversion and measure ROI. This method of incentivizing the consumer may be more cost-effective or generate quicker results for short term testing, than expending marketing dollars to track clicks or integrate information technology with the pharmacies or other consumer health vendors, and their systems of handling personal health information.

Digital Personalized Fertility Health Guide

In a preferred embodiment, the present invention provides a female consumer with a digital personalized fertility health guide (also referred to herein as a “fertility health guide”) that gives actionable recommendations that meet the fertility needs of the consumer based on her age, whether she is trying to conceive and her relationship status. For example, fertility recommendations for a same-sex female couple are vastly different from those given to a heterosexual couple because the former requires donor sperm and insemination with the help of a healthcare provider. Similarly, a single woman who desires to conceive would need to learn how to procure donor sperm and doing insemination with the help of a healthcare provider.

As noted previously, in application, each section of the digital personalized health guide can convey a specific type or category of information that is useful to the consumer. Within the context of a fertility health guide, the guide can help the consumer to understand her fertility potential by presenting sections on such topics as: what is infertility; when or why do you need to see a fertility specialist; what would a fertility specialist do for you; and what are the common fertility treatment options and their success rates.

In one embodiment, the fertility health guide includes contextual information based on the consumer's health data, professional medical guidelines, and depending on the consumer's age and length of time trying to conceive, a recommendation for consulting a fertility specialist. For women under 35 years of age, the medical recommendation is to consult a fertility specialist after trying to conceive for 12 months or more. For women 35 years of age or over, the medical recommendation is to see a fertility specialist after trying to conceive for 6 months or more. In addition, consumers should feel comfortable to see a fertility specialist anytime that they are concerned or would like to check if they have risk factors for fertility problems. This information is provided in the fertility health guide, but the presentation style to a 38 year old consumer who has tried to conceive without success for 12 months imparts much more empathy and a greater level of gravity than the presentation style to a 32 year old consumer who has tried to conceive for 3 months. For the latter, the presentation style is light, and more oriented to lifestyle rather than a medical problem.

In order to present information about fertility treatment without overwhelming the consumer, the fertility health guide may use a combination of descriptive health content and links to more detailed reading or mobile apps that provide more in-depth features for interested consumers. When delivered via email, text, or other easily retrievable medium, the fertility health guide itself serves as a repository of information and well-referenced links that the consumer can re-read.

In another embodiment, the amount and complexity of health information that is welcome by the consumer also depends on the depth and amount of fertility information she has previously been exposed to, her educational and reading level, her perception of whether she has a fertility problem, her partner's attitude towards trying to conceive and fertility problems, how long she has been trying to conceive, her age and how she perceives ovarian aging, prior exposure to a fertility specialist or diagnostic testing or medical treatment, her personality, influences from her social network, and exposure to fertility problems among her social network. For example, a consumer with 8^{th} grade reading level, who has tried to conceive for 2 years without success and who does not have adequate prior exposure to fertility health information, and who does not realize that she meets the definition of clinical infertility and should see a fertility specialist according to professional recommendations, may be overwhelmed if her fertility guide provides detailed health information pertaining to fertility problems and potential treatments, even though she may benefit from gaining this knowledge. If she were to read a range of fertility health information that is available on the internet, she may not have the analytical and reading comprehension skills to focus on content that is appropriate for her. However, she deserves to be empowered to learn about her fertility condition and how to maximize her chances to have a healthy family. The system of interactive profiling has the ability to learn relevant personal information in order to personalize the scope, depth, and complexity of the fertility health guide, such that fertility health information can be introduced to the consumer in small doses, followed by recommendations or follow up guides that will motivate her to expand her knowledge at a pace that is comfortable to her while continuing to provide actionable health information to help her achieve her family-building goals.

In contrast, the fertility health guide that would meet the needs of another consumer may need to be very different in scope, depth, and complexity. This consumer has a graduate degree in engineering, and is deeply concerned about not having conceived over a 12 month period. She has already consulted a fertility specialist, but questions why information provided by different online references appear to give different advice, and wants to know the status of a few questions in the field of fertility research. The fertility health guide that is appropriate for the consumer in the foregoing paragraph would not meet the needs of this consumer. The system of interactive profiling would learn the consumer's health profile and be able to determine the appropriate content and presentation style for the fertility health guide that is tailored to this consumer.

A major barrier to fertility treatment is the inefficiencies in seeking a fertility specialist, presumably because a large percentage of consumers do not have insurance coverage for fertility medical care, and they suffer from an inefficient referral process in a self-pay market that does not provide efficient comparisons of healthcare providers to the consumer. In such a scenario, the interactive digital profiling of the present invention may discern, through an appropriate branching questionnaire, whether the consumer is looking for a fertility specialist for the first time or is looking for a different fertility specialist. The ensuing fertility health guide will provide suggestions to the consumer on how to choose a fertility specialist and based upon the consumer health profile, the proper time to see the fertility specialist.

In a further embodiment, the fertility health guide may explain the role of ovarian aging and its impact on the recommended pace for seeking fertility treatment. The fertility health guide may also provide content and links to educate the consumer about using advanced prediction tests to learn about her personalized probability of having a baby from different types of fertility treatment, including in vitro fertilization (IVF).

In another embodiment, the interactive digital profiling may have additional branches of questioning to screen for fertility risk factors in order to let a consumer know if she has any fertility risk factors. For example, the interactive digital profiling may seek to learn more about the consumer's failed fertility treatments and the details of those failed treatments. In order to provide relevant information pertaining to alternative fertility treatment options to IVF with the consumer's own eggs, such as IVF with eggs from a female donor, IVF with no or minimal hormonal injection (also called natural IVF or minimal stimulation IVF), embryo donation, and adoption. Detailed information regarding these alternative treatments will not meet the immediate needs of consumers who do not have fertility problems or who have not tried conventional treatments. Many of the consumers that may benefit from learning this information are also very stressed and devastated by their failed IVF treatments. Aside from the content, the presentation style may be tested for its effectiveness in helping consumers move to next-steps and the impact of the delivery on their psychological well-being.

In a further embodiment, follow up fertility health guides that have increased complexity or depth of content, or increasing level of gravity of tone regarding action items, are sent to consumers to remind or encourage them to take next-steps in their health needs navigation. If appropriate, a series of fertility health guides may be sent at pre-designated times to meet the consumer's health needs.

In another embodiment, a duplicate or follow-up interactive digital profiling quiz will sent to the consumer at specific time intervals in order to update the consumer health profile regarding potential new health concerns or the follow up of a prior health concern, such as fertility. An updated fertility health guide will then be sent to the consumer based on the updated consumer health profile, the consumer's history of prior encounters with the interactive digital profiling, the consumer's prior consumer health profiles, and the consumer's prior fertility health guide(s). Depending on the consumer's prior response to the interactive digital profiling quiz and whether she clicks on links or takes any actions, the same or different quiz may be sent to the consumer at the next specified time.

Utility

The system of interactive digital profiling, consumer health profiling, and the generation of a digital personalized health guide may be operated by and/or sub-licensed to a content provider, companies such as pharmaceutical, biotechnology, or consumer goods companies, healthcare providers such as large provider networks, or payers.

It is to be understood that the digital personalized health guides (which are intended to include the fertility health guides disclosed herein) of the present invention are not medical advisory; they are tools for offering recommendations to a consumer that wants to obtain more information about a health topic, health product, healthcare provider, or the need for a medical evaluation and/or advisory. If appropriate, the digital personalized health guides may be approved and stamped by a healthcare provider to serve as medical advisory or recommendations.

The present invention may be applied to all areas of healthcare. All references made herein to women's health and chronic diseases are made solely to illustrate the applications of the interactive digital profiling platform, the consumer health profile, and the digital personalized health guide of the present invention.

### Prophetic Example 1

A interactive digital profiling quiz targeted at female consumers in the 45 and above age group has one or more digital entry points directly on the interactive profiling quiz or indirectly via an ad at a health content website, Facebook® or other social media platforms, a search engine, a text or text app, an email correspondence or an email link, a digital newsletter or a link from a digital newsletter. Once accessed, the interactive profiling quiz asks the consumers ten questions related to demographics such as age, body mass index, ethnicity, country of origin; general health status including questions related to current or risks of hypertension, heart disease, thromboembolic disease, bone health, cancer and especially breast cancer; family history such as breast cancer; lifestyle questions regarding weight-bearing exercise, fitness, diet, health supplements, any hormonal replacement; and health questions specifically related to menstruation, menopause, menopausal symptoms such as hot flushes, dry skin, and questions related to sexual function such as sexual orientation, libido, types and frequency of sexual activities, sexual pleasure, vaginal dryness. The interactive profiling also asks the consumer to enter in free text the most urgent unmet needs or challenges in entering menopause that she may have encountered. Such unmet needs may be within the general context of having an impact on the consumer's lifestyle or within the more specific context of having access or experience with health products and services. Data collected from the interactive profiling is compiled in data tables and analyzed with one or more techniques, such as logic programs, machine learning, natural language processing, and/or other techniques used in artificial intelligence to generate the consumer health profile for the female consumer. Next, analysis of the data from the consumer health profile data determines and generates content pertaining to health information that meets the needs expressed by the consumer plus the essential template information for the health topic of menopause. The analysis further determines the presentation style for the digital personalized health guide (in this case a personalized menopause health guide) that is best suited to the consumer based on her demographics, personal information, and other preferences that are extracted from different categories of the consumer health profile.

The delivery of the personalized menopause health guide provides an easy-to-understand introduction to a multi-faceted topic that is perceived differently by different consumers. Although many health products may help consumers to make the menopausal transition healthier and more enjoyable, a stark display of advertisements of these health products may not communicate their benefits well to consumers. The personalized menopause health guide is designed to provide a light discussion of menopausal symptoms, links to more in-depth articles, and an introduction to several health products that may support the consumer when dealing with one or more menopausal symptom or the overall lifestyle changes. In the current or follow-up menopause health guide—depending on the consumer's prior exposure or menopausal product purchase experience—advertisements for relevant consumer products related to menopause will be shown to the consumer, who would be asked to submit pharmacy receipts in the case of a product coupon for tracking, and in the case of rebates or redeemable awards, the tracking information would be known within the consumer health profile.

To the consumer, the personalized menopause health guide allows the consumer to learn how she can feel better, be healthier, and have greater enjoyment of lifestyle pleasures, through the review of editorial health content and health product advertisements. By contrast, the ROI of the personalized menopause health guide is measured in terms of marketing dollars spent, the number of unique consumers targeted by the interactive digital profiling quiz, the number and percentage of consumers that receive the menopausal health guide, and the number and percentage of consumers that purchase one or more health products.

### Prophetic Example 2

The interactive digital profiling platform, consumer health profile, and digital personalized health profile of Prophetic Example 1 may be used with equal success in other areas of women's health to disseminate health and health product information relating to conditions such as birth control, sexually transmitted disease prevention or treatment, conception issues, management of pregnancy, health issues or complications arising from pregnancy, fertility problems, problems with menstrual cycles, irregular menstruation, health issues arising from the transition to menopause, and/or female sexual concerns or dysfunction.

### Prophetic Example 3

The interactive digital profiling platform, consumer health profile, and digital personalized health profile of Prophetic Examples 1 and 2 may be used with equal success in other areas of chronic diseases to disseminate health and health product information relating to conditions such as migraine headaches, eczema, arthritis, chronic inflammatory bowel disease, constipation, chronic sinusitis, glaucoma, hearing loss, hypertension, diabetes, heart disease, chronic vascular insufficiency, recurrent bladder infection, kidney stone, heart burn and indigestion, chronic diarrhea, chronic liver disease, musculoskeletal conditions such as tendonitis, fibromyalgia and fasciitis, multiple sclerosis, and psychiatric illnesses such as depression and anxiety.

I claim:

1. A system comprising:
(A) an interactive digital profiling questionnaire directed to a consumer of health information, wherein the consumer provides answers to questions provided in the interactive digital profiling questionnaire, wherein the questions and answers relate to a health status or condition of the consumer and the questions are presented to obtain information about the consumer's perception of the health status or condition;
(B) a consumer health profile comprising a data presentation software application comprising pre-defined sections, wherein the consumer's answers from the interactive digital questionnaire are entered as health data into the pre-defined sections of the data presentation software application , wherein the consumer health profile is not visible to the consumer; and
(C) a digital personalized health guide for delivery to the consumer comprising one or more logic programs, a concatenation function, and pre-defined topical categories, wherein the one or more logic programs and the concatenation function retrieve health data from the consumer health profile and organize the health data into the pre-defined topical categories, and further wherein the health data is provided to the consumer with a presentation style appropriate to the consumer's perception of the health status or condition and the consumer can view the health data in the digital personalized health profile according to any of the pre-defined categories, wherein the pre-defined topical categories of the computer-generated personalized health guide will vary in content, length, complexity, tone, style, seriousness, and detail depending on (i) the answers provided by the consumer in the interactive digital profiling questionnaire, (ii) the health data in the pre-defined sections of the consumer health profile, and (iii) the organization of the health data by the one or more logic programs and the concatenation function of the digital personalized health guide.

2. The system of claim 1(A), wherein the interactive digital profiling questionnaire is selected from the group consisting of a text-based questionnaire, a non-textual visual questionnaire, an audio-based verbal questionnaire, and a video-based questionnaire.

3. The system of claim 2, wherein answers to the non-textual visual questionnaire, the audio-based verbal questionnaire, and the video-based questionnaire are converted to text for automatic entry into the data presentation software application of the consumer health profile.

4. The system of claim 1(A), wherein the interactive digital profiling questionnaire includes questions relating to the consumer's physical, psychological, emotional, social status, financial status, and interest in the health status or condition.

5. The system of claim 1(B), wherein, the data presentation software application is a spreadsheet or a set of content look-up tables.

6. The system of claim 5, wherein the data presentation software application uses a mail merge function to concatenate content of the digital personalized health guide.

7. The system of claim 1(C), wherein the one or more logic programs are selected from the group consisting of Markov decision processes, hierarchical task networks, natural language processing, machine learning, statistical methods, neural network, and Bayesian networks.

8. The system of claim 1(C), wherein the pre-defined topical categories of the digital personalized health guide are selected from the group consisting of demographics, general health status, general health needs, lifestyle information, family health history, laboratory data, and the consumer's needs in relation to the consumer's health status or condition.

9. The system of claim 1, wherein the consumer is an individual or a couple and the health status or condition is fertility and/or a live birth of one or more healthy children, wherein the individual or couple is learning about his/her/their fertility; learning how to preserve his/her/their fertility potential; attempting to conceive; or undergoing fertility treatment.

10. The system of claim 9, wherein the health status or condition is a fertility status or condition and the digital personalized health guide includes an analysis on how the consumer's lifestyle, activities, finances, and physical, psychological, and social well-being influence the consumer's fertility status or condition.

11. The system of claim 10, wherein the consumer's fertility status or condition is selected from the group consisting of perceived fertility potential, perceived probability of a live birth event from one or more fertility treatments, and level of concern about fertility.

12. The system of claim 9, wherein the digital personalized health guide includes recommendations for treatments and advertisements for products that may improve the consumer's fertility status or condition.

13. The system of claim 1(A), wherein the consumer is an individual or a couple that is trying to conceive or is expecting one or more children and the health status or condition is selected from the group consisting of maximizing health of a fetus or unborn child, minimizing risk of disease of a fetus or unborn child, and minimizing harmful effects of a known or potential disease to a fetus or unborn child.

14. The system of claim 1(A), wherein the consumer is an individual or a couple and the health status or condition is the consumer's interest in having a healthy child or interest in learning how to have a healthy child, wherein the health status or condition leads the consumer to receive pre-conception health recommendations selected from the group consisting of exercise programs, diet information, nutritional supplements, lifestyle changes, pre-conception genetic testing of the consumer and/or the consumer's partner to determine carrier status for genetic diseases, prenatal genetic testing, and genetic testing of family members of the consumer.

15. The method of claim 14, wherein family members of the consumer are selected from the group consisting of offspring of the consumer, immediate family members of the consumer, and extended family members of the consumer.

16. The system of claim 1(A), wherein the consumer is an individual or a couple and the health status or condition is selected from diagnostic or screening tests to select embryos with a high likelihood of viability and/or a low risk of serious health conditions, wherein the genetic tests are selected from the group consisting of time-lapse imaging of pre-implantation embryo development, pre-implantation genetic screening, pre-implantation genetic diagnosis, biochemical testing, testing of metabolites in a pre-implantation embryo culture environment, screening for genetic variants in embryos, screening for genetic variants in a male that is a sperm source of an embryo, and screening for genetic variants in a female that is an egg source of an embryo.

17. The system of claim 1(A), wherein the consumer is an individual and the health status or condition is selected from the group consisting of assessing the consumer's risk of developing one or more diseases, preventing or delaying onset of one or more diseases that pose a health risk to the consumer, and ameliorating symptoms of one or more pre-existing diseases of the consumer.

18. The system of claim 17, wherein the one or more diseases and pre-existing diseases are selected from the group consisting of cancer, Alzheimer's disease, Parkinson's disease, cardiovascular diseases, kidney diseases, diabetes, liver diseases, hepatitis B, hepatitis C, human immunodeficiency virus (HIV), multiple sclerosis, and rheumatoid arthritis.

19. The system of claim 1(C), wherein the digital personalized health guide includes information for assessing the consumer's risk of developing one or more diseases, information for preventing or delaying onset of one or more diseases, and information for ameliorating symptoms of one or more pre-existing diseases, wherein the information is selected from the group consisting of genetic screening tests, genetic diagnostic tests, and re-analysis of previously performed genetic tests.

20. The system of claim 1(C), wherein the digital personalized health guide includes information on menopausal health selected from the group consisting of lifestyle changes to decrease unpleasant menopausal symptoms, diet changes to decrease unpleasant menopausal symptoms, cardiovascular health, bone health, emotional wellness, and enhancement of sexual function.
